(19) United States
(12) Patent Application Publication
(10) Pub. No.: US 2004/0194153 A1
(43) Pub. Date: Sep. 30, 2004

(54) Conservation of system resources by efficiently activating/de-activating applications

(75) Inventors: Ashish Garg, Santa Clara, CA (US); Phuong Viet Nguyen, San Jose, CA (US)

Correspondence Address: HAVERSTOCK & OWENS LLP, 162 NORTH WOLFE ROAD, SUNNYVALE, CA, 94086, US

(73) Assignee: Sony Corporation and Sony Electronics Inc.

(21) Appl. No.: 10/396,765

(22) Filed: Mar. 24, 2003

(51) Int. Cl. H04N 7/16; H04N 7/173

(52) U.S. Cl. 725/151

(57) ABSTRACT

A method and apparatus optimize the use of system resources when switching between applications. Preferably, the apparatus includes a processor, a secondary memory and a system memory. Applications previously loaded into system memory from the secondary memory are set to either an active state or an inactive state. In the active state, the processor actively processes the application and a portion of the system memory is used by the processor for active processing. In the inactive state, neither the processor nor the portion of the system memory dedicated for active processing is used by the application. Preferably, only one application is in the active state at any given time. When multiple applications are currently stored in system memory, one of the applications is set to the active state while the other applications are set to the inactive state. When one of the inactive state applications is selected for use, the currently active state application is de-activated so that all applications stored in system memory are set to the inactive state. Then, the selected application is set to the active state.

### FIELD OF THE INVENTION

The present invention relates to the field of application system resource management. More particularly, the present invention relates to the field of conserving system resources by efficiently activating/de-activating applications within a set-top box.

### BACKGROUND OF THE INVENTION

In many hardware devices, system resources such as memory and processing power are scaled to meet current device application requirements and/or to reduce costs. Such devices typically include a number of applications which are stored in a secondary storage device within the device. When an application is first used after the device is powered on, the application is loaded from the secondary storage device to random access memory (RAM). This process requires system resources and time to perform. Switching between active applications in a multi-application environment puts additional strain on a device with limited system resources. System resource management is a primary concern in devices comprising limited system resources. In particular, television set-top boxes and related interactive televisions include limited system resources.

Set-top boxes are often used as intermediary devices between a content source, such as a personal computer or a remote cable televison provider, and a display device, such as a television. Often, set-top boxes include multiple applications including content menus and display parameter settings. When initially loading these applications into RAM or when switching from one application to another, overtaxed system resources may lead to excessive delays and/or system failures. Further, if a device with limited system resources is capable of receiving new or upgraded applications, such enhancements may lead to further delays and system failures.

### SUMMARY OF THE INVENTION

Embodiments of the present invention provide a method and apparatus for optimizing the use of system resources when switching between applications. Preferably, the apparatus implementing the present invention includes a processor, a secondary memory and a system memory. Applications previously loaded into system memory from the secondary memory are set to either an active state or an inactive state. In the active state, the processor actively processes the application and a portion of the system memory is used by the processor for active processing. In the inactive state, neither the processor nor the portion of the system memory dedicated for active processing is used by the application. Preferably, only one application is in the active state at any given time. When multiple applications are currently stored in system memory, one of the applications is set to the active state while the other applications are set to the inactive state. When one of the inactive state applications is selected for use, the currently active state application is de-activated so that all applications stored in system memory are set to the inactive state. Then, the selected application is set to the active state.

In one aspect of the present invention, a method optimizes the use of system resources when switching between applications. The method includes maintaining a first application in an active state while maintaining a second application in an inactive state, selecting the second application by a user, de-activating the first application such that the first application and the second application are in the inactive state, and activating the second application while maintaining the first application in the inactive state. A central processing unit (CPU) of the application device does not actively process the first application while the first application is in the inactive state. The CPU does not actively process the second application while the second application is in the inactive state. A first portion of a system memory of the application device stores the first application while the first application is in the active state or in the inactive state. The first portion of the system memory stores the second application while the second application is in the active state or in the inactive state. The first portion of the system memory can comprise random access memory (RAM). Deactivating the first application can comprise de-allocating the CPU and a second portion of the system memory from the first application. Activating the second application can comprise allocating the CPU and the second portion of the system memory to the second application. The second portion of the system memory provides an active processing memory requirement of the CPU. When the first application is in the active state, the first application is preferably the only application that utilizes the CPU and the second portion of the system memory. Activating the first application comprises the CPU actively processing the first application, thereby placing the first application in the active state. Preferably, a single application is in an active state at a given time. The first application and the second application are previously launched prior to maintaining, selecting, de-activating and activating.

In another aspect of the present invention, a device includes a processor, and a system memory including at least a first and a second loaded applications, wherein the first application is set to an active state and the second application is set to an inactive state, such that in operation when the second application is selected for active processing, the processor firstly de-activates the first application such that the first application and the second application are set to the inactive state, and the processor secondly activates the second application thereby setting the second application to an active state while maintaining the first application in the inactive state. The processor does not actively process the first application while the first application is in the inactive state. The processor does not actively process the second application while the second application is in the inactive state. A first portion of the system memory stores the first application while the first application is in the active state or in the inactive state. The first portion of the system memory stores the second application while the second application is in the active state or in the inactive state. The first portion of the system memory can comprise random access memory (RAM). The processor deactivates the first application by de-allocating the processor and a second portion of the system memory from the first application. The processor activates the second application by allocating the processor and the second portion of the system memory to the second application. The second portion of the system memory provides an active processing memory requirement of the processor. When the first application is in the active state, the first application can be the only application that utilizes the processor and the second portion of the system memory. The processor activates the first application by allocating the processor to the first application, thereby placing the first application in the active state. Preferably, a single application is in an active state at a given time.

### BRIEF DESCRIPTION OF THE DRAWINGS

FIG. 1 illustrates an exemplary set-top box according to the present invention.

FIG. 2 illustrates a use of system resources when switching between applications.

FIG. 3 illustrates a preferred process of the present invention in which the use of system resources when switching between applications is optimized.

### DETAILED DESCRIPTION OF THE EMBODIMENTS

The present invention provides a method and apparatus for optimizing the use of system resources when switching between applications. The present invention is preferably implemented within a device comprising limited system resources, in particular a limited amount of processing power. The present invention can also be implemented within a device in which system resources are not so tightly constrained. Preferably, the device implementing the present invention includes a processor, a secondary memory and a system memory. The system memory preferably includes random access memory (RAM) onto which a plurality of applications are loaded from the secondary memory. Applications are set to either an active state or an inactive state. In the active state, the processor actively processes the application and a portion of the system memory is used by the processor for active processing. In the inactive state, neither the processor nor the portion of the system memory dedicated for active processing are used by the application. Preferably, only one application is in the active state at any given time. When multiple applications are currently stored in RAM, one of the applications is set to the active state while the other applications are set to the inactive state. When one of the inactive state applications is selected for use, the currently active state application is de-activated so that all applications stored in RAM are set to the inactive state. Then, the selected application is set to the active state. In this manner, only one application is set to the active state at any given time, even when switching from one application to another.

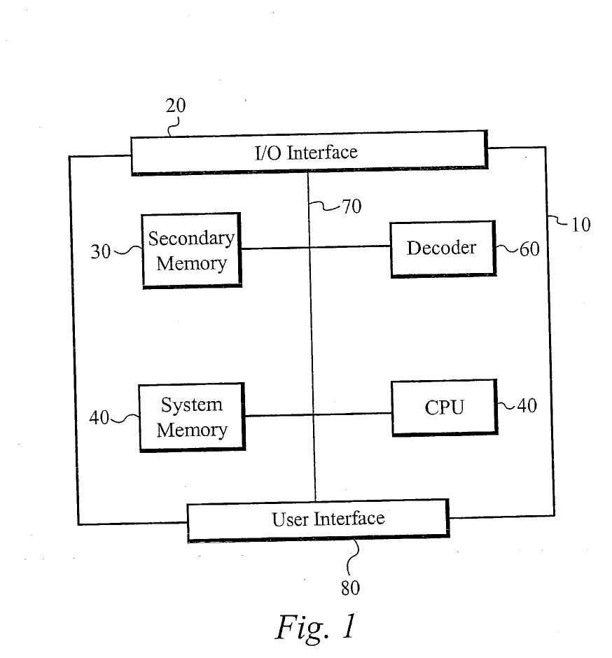

FIG. 1 illustrates an exemplary set-top box according to the present invention. The set-top box preferably controls the transmission of multimedia from a local storage device, such as a personal computer (PC), to a television or from a remote content provider, such as a cable television provider, to the television. The set-top box 10 includes an input/output (I/O) interface 20, a secondary memory 30, a system memory 40, a central processing unit (CPU) 50, a user interface 80, and a decoder 60 all coupled via a bi-directional bus 70. The I/O interface 20 preferably couples the set-top box 10 to a content source (not shown) for receiving multimedia and to the television (not shown) or other display device for displaying the multimedia received from the content source. The I/O interface 20 can also be coupled to a conventional network, such as the Internet, to receive periodic software upgrades including new versions of operating software and new or upgraded applications. The I/O interface 20 also sends and receives control signals to and from the user interface 80 and the television. The user interface 80 preferably comprises a keypad and display, as is well known in the art. Alternatively, the user interface 80 comprises any conventional user interface.

The secondary memory 30 stores the software used to enable operation of the set-top box 10 along with a plurality of applications. Exemplary applications include, but are not limited to a menu of available content such as an on-screen television guide, and display parameter settings such as color, tint, and brightness. Preferably, the secondary memory 30 is flash memory. Alternatively, any conventional type of memory can be used. Preferably, the system memory 40 includes random access memory (RAM). The system memory 40 can also include additional buffers, registers, and cache according to specific design implementations. Multimedia received by the set-top box 10 is preferably encrypted to prevent unauthorized access and use, and the decoder 60 decrypts the multimedia according to access authorization provided by the CPU 50.

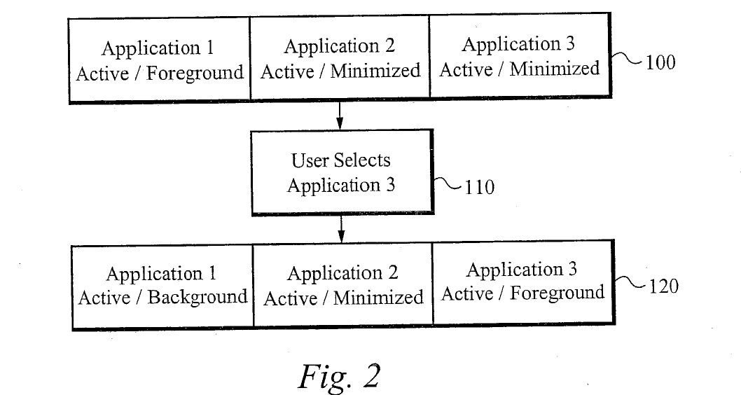

FIG. 2 illustrates a use of system resources when switching between applications. At the step 100, all applications previously loaded into RAM are set to an active state. In particular, application 1 is set to an active state and placed in the foreground, application 2 is set to an active state and minimized, and application 3 is set to an active state and minimized. Alternatively, either application 2, application 3, or both can be set to the active state and placed in the background. An application in the active state is actively processed by the processor and a portion of the system memory is used by the processor for active processing. Preferably, the portion of system memory used by the processor during active processing includes a buffer, a register, a cache, and multiples or combinations thereof. At the step 110, a user selects application 3. In response to the user selection of application 3, in the step 120 application 1 is placed in the background while application 3 is simultaneously placed in the foreground and brought fully active. The first process of the present invention is preferably used when switching times and updates are of a higher priority than the efficient use of processing power and associated system memory. Applications placed in the background and in the foreground constantly use memory and CPU processing when used in the manner illustrated in FIG. 2.

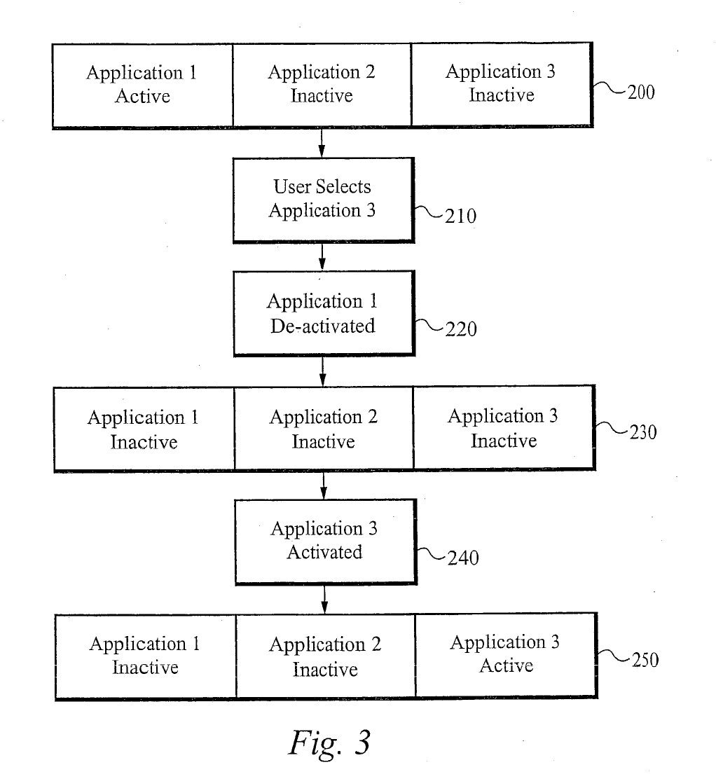

FIG. 3 illustrates a preferred process of the present invention in which the use of system resources when switching between applications is optimized. At the step 200, of the applications previously loaded into RAM, one application is set to an active state while the other applications are set to an inactive state. Specifically, application 1 is set to an active state, application 2 is set to an inactive state and application 3 is set to an inactive state. Similar to the first process of the present invention, an application in the active state is actively processed by the processor and a portion of the system memory is used by the processor for active processing. An application in the inactive state is not actively processed by the processor and the portion of the system memory used by the processor during active processing is clear of any data associated with an application in the inactive state. At the step 210, a user selects application 3. In response to the user selection of application 3, in the step 220 application 1 is de-activated. De-activating an application is an action which triggers a change of state from the active state to the inactive state. When the application is de-activated, the processor is de-allocated from the application and the portion of system memory used for active processing is cleared. De-activation of application 1 in the step 220 results in application 1, application 2, and application 3 all being set to the inactive state, as in the step 230. In other words, as a result of the active state application being de-activated, all applications currently stored in RAM are in the inactive state. In the step 240, application 3 is activated. Activating an application is an action which triggers a change of state from the inactive state to the active state. When the application is activated, the processor is allocated to the application. Since the portion of the system memory used for active processing was previously cleared during de-activation, the portion of system memory is ready to be used for active processing by the processor. Activation of application 3 in the step 240 results in application 3 being set to the active state and application 1 and application 2 remaining set in the inactive state, as in the step 250. In the second process of the present invention, a single application is set to the active state at any given time. The second process is preferably used when efficient use of processing power and associated system memory are a primary concern.

In operation, a system memory includes a plurality of applications previously loaded from a secondary memory. One of the applications is set to an active state while the remaining applications are set to an inactive state. When one of the applications in the inactive state is selected for use, the application which is currently in the active state is de-activated such that all applications resident in the system memory are set to the inactive state. During de-activation, a processor and a portion of the system memory used by the processor during active processing is de-allocated from the previously active state application. Then, the selected application is set to the active state, thereby allocating the processor and the portion of the system memory used for active processing to the selected application. In this manner, only a single application is set to the active state at any given time.

The present invention has been described in terms of specific embodiments incorporating details to facilitate the understanding of the principles of construction and operation of the invention. Such references, herein, to specific embodiments and details thereof are not intended to limit the scope of the claims appended hereto. It will be apparent to those skilled in the art that modifications can be made in the embodiments chosen for illustration without departing from the spirit and scope of the invention. Specifically, it will be apparent to one of ordinary skill in the art that while the preferred embodiment of the present invention is used with set-top boxes, the present invention can also be implemented on any other appropriate system resource limited device.

What is claimed is:

1. A method to optimize use of system resources when switching between applications, the method comprising:
a. maintaining a first application in an active state while maintaining a second application in an inactive state;
b. selecting the second application by a user;
c. de-activating the first application such that the first application and the second application are in the inactive state; and
d. activating the second application while maintaining the first application in the inactive state.

2. The method of claim 1 wherein a central processing unit (CPU) of the application device does not actively process the first application while the first application is in the inactive state.

3. The method of claim 2 wherein the CPU does not actively process the second application while the second application is in the inactive state.

4. The method of claim 3 wherein a first portion of a system memory of the application device stores the first application while the first application is in the active state or in the inactive state.

5. The method of claim 4 wherein the first portion of the system memory stores the second application while the second application is in the active state or in the inactive state.

6. The method of claim 4 wherein the first portion of the system memory comprises random access memory (RAM).

7. The method of claim 2 wherein deactivating the first application comprises de-allocating the CPU and a second portion of the system memory from the first application.

8. The method of claim 7 wherein activating the second application comprises allocating the CPU and the second portion of the system memory to the second application.

9. The method of claim 8 wherein the second portion of the system memory provides an active processing memory requirement of the CPU.

10. The method of claim 9 wherein when the first application is in the active state, the first application is the only application that utilizes the CPU and the second portion of the system memory.

11. The method of claim 2 wherein activating the first application comprises the CPU actively processing the first application, thereby placing the first application in the active state.

12. The method of claim 1 wherein a single application is in an active state at a given time.

13. The method of claim 1 wherein the first application and the second application are previously launched prior to maintaining, selecting, de-activating and activating.

14. A device comprising:
a. a processor; and
b. a system memory including at least a first and a second loaded applications, wherein the first application is set to an active state and the second application is set to an inactive state, such that in operation when the second application is selected for active processing, the processor first de-activates the first application such that the first application and the second application are set to the inactive state, and then the processor activates the second application thereby setting the second application to an active state while maintaining the first application in the inactive state.

15. The device of claim 14 wherein the processor does not actively process the first application while the first application is in the inactive state.

16. The device of claim 15 wherein the processor does not actively process the second application while the second application is in the inactive state.

17. The device of claim 16 wherein a first portion of the system memory stores the first application while the first application is in the active state or in the inactive state.

18. The device of claim 17 wherein the first portion of the system memory stores the second application while the second application is in the active state or in the inactive state.

19. The device of claim 17 wherein the first portion of the system memory comprises random access memory (RAM).

20. The device of claim 14 wherein the processor deactivates the first application by de-allocating the processor and a second portion of the system memory from the first application.

21. The device of claim 20 wherein the processor activates the second application by allocating the processor and the second portion of the system memory to the second application.

22. The device of claim 21 wherein the second portion of the system memory provides an active processing memory requirement of the processor.

23. The device of claim 22 wherein when the first application is in the active state, the first application is the only application that utilizes the processor and the second portion of the system memory.

24. The device of claim 14 wherein the processor activates the first application by allocating the processor to the first application, thereby placing the first application in the active state.

25. The device of claim 14 wherein a single application is in an active state at a given time.

26. An apparatus to optimize use of system resources when switching between applications, the apparatus comprising:
a. means for maintaining a first application in an active state while maintaining a second application in an inactive state;
b. means for selecting the second application by a user;
c. means for de-activating the first application such that the first application and the second application are in the inactive state; and
d. means for activating the second application while maintaining the first application in the inactive state.

27. The apparatus of claim 26 further comprising a central processing unit (CPU), wherein the CPU does not actively process the first application while the first application is in the inactive state.

28. The apparatus of claim 27 wherein the CPU does not actively process the second application while the second application is in the inactive state.

29. The apparatus of claim 28 further comprising a system memory, wherein a first portion of the system memory stores the first application while the first application is in the active state or in the inactive state.

30. The apparatus of claim 29 wherein the first portion of the system memory stores the second application while the second application is in the active state or in the inactive state.

31. The apparatus of claim 29 wherein the first portion of the system memory comprises random access memory (RAM).

32. The apparatus of claim 27 wherein the means for deactivating the first application comprises means for de-allocating the CPU and a second portion of the system memory from the first application.

33. The apparatus of claim 32 wherein the means for activating the second application comprises means for allocating the CPU and the second portion of the system memory to the second application.

34. The apparatus of claim 33 wherein the second portion of the system memory provides an active processing memory requirement of the CPU.

35. The apparatus of claim 34 wherein when the first application is in the active state, the first application is the only application that utilizes the CPU and the second portion of the system memory.

36. The apparatus of claim 27 wherein the means for activating the first application comprises the CPU actively processing the first application, thereby placing the first application in the active state.

37. The apparatus of claim 26 wherein a single application is in an active state at a given time.

38. A set-top box comprising:
a. a processor; and
b. a system memory including at least a first and a second loaded applications, wherein the first application is set to an active state and the second application is set to an inactive state, such that in operation when the second application is selected for active processing, the processor first de-activates the first application such that the first application and the second application are set to the inactive state, and then the processor activates the second application thereby setting the second application to an active state while maintaining the first application in the inactive state.

39. The set-top box of claim 38 wherein the processor does not actively process the first application while the first application is in the inactive state.

40. The set-top box of claim 39 wherein the processor does not actively process the second application while the second application is in the inactive state.

41. The set-top box of claim 40 wherein a first portion of the system memory stores the first application while the first application is in the active state or in the inactive state.

42. The set-top box of claim 41 wherein the first portion of the system memory stores the second application while the second application is in the active state or in the inactive state.

43. The set-top box of claim 41 wherein the first portion of the system memory comprises random access memory (RAM).

44. The set-top box of claim 38 wherein the processor deactivates the first application by de-allocating the processor and a second portion of the system memory from the first application.

45. The set-top box of claim 44 wherein the processor activates the second application by allocating the processor and the second portion of the system memory to the second application.

46. The set-top box of claim 45 wherein the second portion of the system memory provides an active processing memory requirement of the processor.

47. The set-top box of claim 46 wherein when the first application is in the active state, the first application is the only application that utilizes the processor and the second portion of the system memory.

48. The set-top box of claim 38 wherein the processor activates the first application by allocating the processor to the first application, thereby placing the first application in the active state.

49. The set-top box of claim 38 wherein a single application is in an active state at a given time.

50. The set-top box of claim 38 further comprising a user interface to receive command instructions and application selections from the user.

51. The set-top box of claim 38 further comprising an input/output interface to couple the set-top box to a television via a network.
